(19) United States
(12) Patent Application Publication
(10) Pub. No.: US 2026/0071686 A1
(43) Pub. Date: Mar. 12, 2026

(54) CARTRIDGE VALVE AND ASSOCIATED CARTRIDGE VALVE ASSEMBLY

(71) Applicant: SCHRADER, PONTARLIER (FR)

(72) Inventor: Thomas CHANAL, Pontarlier (FR)

(21) Appl. No.: 19/248,093

(22) Filed: Jun. 24, 2025

(30) Foreign Application Priority Data
Jun. 28, 2024 (FR) 2407052

(51) Int. Cl. F16K 11/083; F16K 27/06

(52) U.S. Cl. CPC F16K 11/0833; F16K 27/062; F16K 2200/501

(57) ABSTRACT

A cartridge valve intended to be mounted in a suitable housing arranged in a receiving frame includes a chassis, a plug rotatably mounted on the chassis and comprising: a main body provided with fluid passages opening into an outer axial wall of the main body via at least two outlet ports, and a drive shaft capable of being coupled to an actuator to control the rotation of the plug, a peripheral axial wall assembly which is integral with the chassis, the peripheral axial wall assembly being provided with a plurality of radial openings intended to be aligned inwardly with outlet ports of the plug, in determined angular positions of the plug, and outwardly with associated ducts of the receiving frame.

### CROSS-REFERENCE TO RELATED APPLICATIONS

The present application claims priority to French Application No. 2407052 filed with the Intellectual Property Office of France on Jun. 28, 2024, which is incorporated herein by reference in its entirety for all purposes.

### TECHNICAL FIELD OF THE INVENTION

The present application relates to a cartridge valve, that is a valve intended to be mounted in a housing belonging to a frame.

The present application relates more particularly to a multiway cartridge valve configured to allow the circulation of a fluid along several fluid passageways.

### TECHNICAL BACKGROUND

Multiway valves are commonly used to allow a fluid to be directed through different fluid passageways depending on the desired use.

Typically, the multiway cartridge type valves are composed of a plug rotatably mounted with respect to a frame which is attached to a receiving frame. The receiving frame comprises ducts that open out opposite the plug. The plug comprises a main body provided with fluid passages opening into an outer axial wall of the main body via outlet ports.

The plug can be provided with fluid sealing elements so as to seal the fluid passageway formed between the ducts of the receiving frame and the outlet ports of the fluid passages.

However, the positioning of the fluid sealing elements on the plug presents shortcomings notably in terms of their correct positioning and also in terms of the robustness of this positioning over time.

Furthermore, the manufacturing and handling operations relating to delivering finished parts to the site responsible for assembling the valves in the receiving frames are not optimized which increases manufacturing costs and complicates assembly operations. In addition, dynamic sealing cannot be guaranteed by the supplier.

Thus, there is currently a need to propose an improved cartridge valve.

### SUMMARY OF THE INVENTION

The invention proposes a cartridge valve intended to be mounted in a suitable housing arranged in a receiving frame, comprising:
a frame intended to be attached directly to the receiving frame,
a plug rotatably mounted on the frame about a main axis of rotation, the plug comprising:
a main body provided with fluid passages opening into an outer axial wall of the main body via at least two outlet ports, and
drive shaft which extends from the main body through a portion of the frame, so as to be able to be coupled to an actuator capable of controlling the rotation of the plug,
a peripheral axial wall assembly which is integral with the frame, prior to mounting the valve in its housing, the peripheral axial wall assembly being provided with a plurality of radial openings intended to be aligned inwardly with outlet ports in the plug, in determined angular positions of the plug, and outwardly with associated ducts of the receiving frame.

According to other features of the cartridge valve:
the peripheral axial wall assembly comprises at least two added peripheral axial wall elements which are attached to the frame so that they can be carried by the frame before the valve is mounted in its housing, each peripheral axial wall element being provided with a radial opening, each peripheral axial wall element comprising an attachment portion capable of enabling it to be hooked onto a complementary receiving portion of the frame, before the valve is mounted in its housing;
the attachment portion of each peripheral axial wall element comprises an elastic interlocking member capable of engaging with a complementary element of the associated receiving portion of the frame;
the receiving portion of the frame comprises, for each peripheral axial wall element, an axial groove capable of receiving the attachment portion and a notch capable of receiving, by elastic interlocking, the elastic interlocking member for retaining the attachment portion on the receiving portion;
each radial opening is provided with an annular seal which is carried by the assembly of peripheral axial walls, prior to mounting the valve in its housing, so as to be interposed radially between the main body of the plug and a bearing surface facing the receiving frame, when the valve is mounted in its housing;
the annular seal and the peripheral axial wall assembly are made from one single piece by molding two different materials;
the main body of the plug has a frustoconical shape with a diameter decreasing towards the end opposite the frame, and the peripheral axial wall assembly is configured so that its external dimension is also frustoconical in shape, matching the frustoconical shape of the main body of the plug;
the peripheral axial wall assembly comprises a tubular end portion, on the opposite side to the frame, which is configured to axially guide the valve when mounted in its housing;

Also proposed is a cartridge valve assembly comprising:
a valve according to any of the preceding features,
a receiving frame provided with a housing adapted to the valve, the frame comprising at least two ducts which open into the housing via radial orifices intended to be radially aligned with outlet ports of the plug in at least one determined angular position of the plug.

According to other features of the cartridge valve assembly:
the internal main wall of the housing has a frustoconical shape which is generally complementary to the frustoconical shape of the main body of the plug fitted with the peripheral axial wall assembly;
the housing comprises a shoulder capable of receiving a tubular section of the frame in axial abutment, and the tubular section of the frame is provided with an outer peripheral annular groove and an O-ring mounted in said outer peripheral annular groove.

### BRIEF DESCRIPTION OF THE FIGURES

Further features and advantages of the invention will become apparent from the following detailed description, which may be understood with reference to the attached drawings in which:

FIG. 1 is a general perspective view of a cartridge valve assembly according to a first embodiment;

FIG. 2 is an axial cross sectional view according to plane II-II which represents the cartridge valve assembly of FIG. 1;

FIG. 3 is a perspective exploded view which shows the cartridge valve belonging to the cartridge valve assembly of FIG. 1;

FIG. 4 is a perspective view similar to that of FIG. 1, without the receiving frame, which represents a second embodiment of a cartridge valve assembly;

FIG. 5 is an axial cross sectional view along plane V-V which shows the cartridge valve assembly of FIG. 4;

FIG. 6 is a perspective view which shows a third embodiment comprising a fluid distribution manifold equipped with two valve assemblies according to the first embodiment;

FIG. 7 is an axial cross sectional view along plane VII-VII which shows the fluid distribution manifold of FIG. 6.

### DETAILED DESCRIPTION OF THE INVENTION

In the following description, identical, similar or analogous elements will be referred to by the same reference numbers.

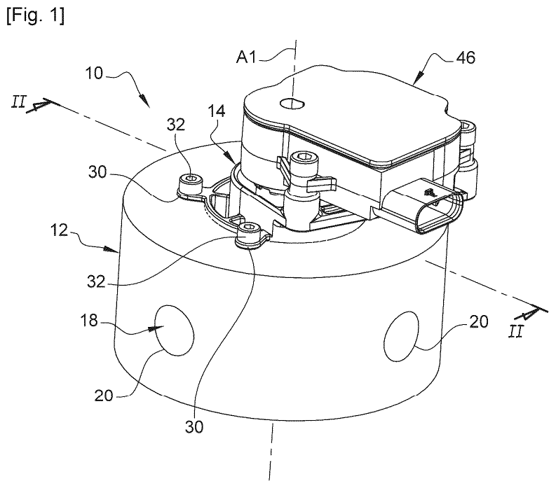

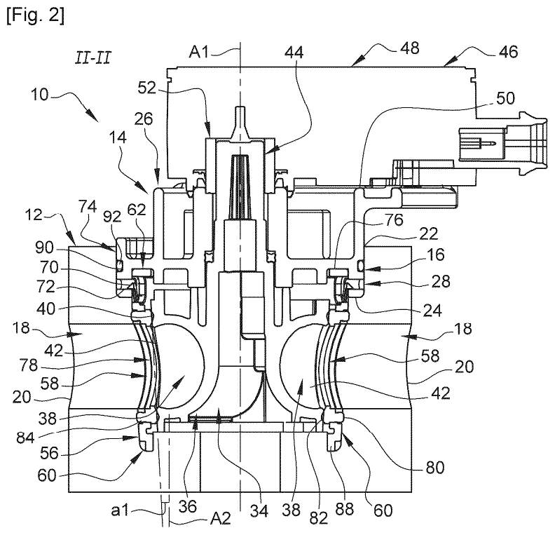

FIGS. 1 and 2 show a cartridge valve assembly 10 comprising a receiving frame 12 and a valve 14 of the multiway cartridge valve type according to a first embodiment.

The valve 14 is intended to be mounted axially, along a main axis A1, in a generally cylindrical housing 16 formed in the receiving frame 12.

In the remainder of the description, an axial orientation along the main axis A1 will be used but is not limited thereto, oriented from bottom to top, as shown in FIGS. 1 and 2. A radial orientation with respect to the main axis A1 is also used.

According to the embodiment shown, the receiving frame 12 is in the form of a cylindrical body with a circular cross-section which extends along the main axis A1 and which comprises several ducts 18. The ducts 18 extend herein radially and open inwardly into the housing 16 and outwardly through outlet openings 20.

Of course, the receiving frame 12 can take different shapes. In particular, the receiving frame 12 may form part of a more complex component. What is important is the shape of the housing 16 and the arrangement of the ducts 18 which must be complementary to the valve 14.

The receiving frame 12 preferably comprises at least two ducts 18 and at most four ducts 18, in the case of a single-stage valve 14 as shown. Of course, it is also possible to provide a different number of ducts 18, which can be superimposed in the case of a multi-stage valve 14.

The housing 16 comprises herein a main opening 22, herein in the upper face of the receiving frame 12, through which the valve 14 is inserted into the housing 16. The main opening 22 is herein provided with a shoulder 24 located above the ducts 18.

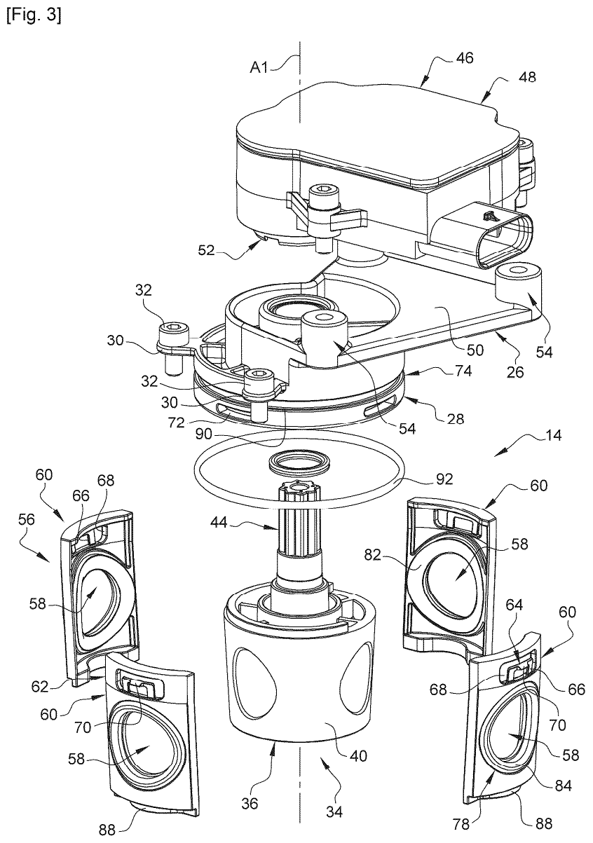

The valve 14 is now described also with reference to FIG. 3.

The valve 14 comprises a chassis 26 which is intended to be attached directly to the receiving frame 12. According to the example shown, the chassis 26 comprises, herein in its lower part, a tubular cylindrical receiving portion 28 which is received in the main opening 22 and which comes to bear axially against the shoulder 24.

The chassis 26 herein comprises attachment lugs 30 positioned to allow the chassis 26 to be attached to the receiving frame 12 by means of screws 32.

The valve 14 comprises a plug 34 rotatably mounted on the chassis 26 about the main axis A1. More particularly, the plug 34 comprises a main body 36 provided with fluid passages 38 opening into an outer axial wall 40 of the main body 36 via a plurality of outlet ports 42, herein four radially opposed outlet ports 42.

The plug 34 comprises a drive shaft 44 which extends from the main body 36 through a portion of the chassis 26, so that it can be coupled to an actuator 46 capable of controlling the rotation of the plug 34.

According to the embodiment shown, the actuator 46 is herein in the form of an electric motor arranged in a housing 48, the housing 48 being mounted on the chassis 26, herein on its upper face 50.

The actuator 46 comprises a drive member 52 capable of driving the drive shaft 44, for example an inner ring gear which engages with external teeth formed on a section of the drive shaft 44.

The chassis 26 is herein provided with attachment studs 54 intended to allow the housing 48 to be screwed into the chassis 26.

Advantageously, the valve 14 comprises an assembly of peripheral axial walls 56 which are integral with the chassis 26, prior to mounting the valve 14 in its housing 16.

The peripheral axial wall assembly 56 is provided with a plurality of radial openings 58 which are intended to be aligned radially inwardly with the outlet ports 42 of the plug 34, in determined angular positions of the plug 34, and outwardly with the associated ducts 18 of the receiving frame 12.

According to the first embodiment, the peripheral axial wall assembly 56 comprises a plurality of added peripheral axial wall elements 60, herein four in number, which are attached to the chassis 26 so that they can be carried by the chassis 26 prior to mounting the valve 14 in its housing 16.

Each peripheral axial wall element 60 is herein in the form of a removable plate curved so as to follow the overall curvature of the outer axial wall 40 of the main body 36 of the plug 34.

Each peripheral axial wall element 60 comprises a radial opening 58 herein of a diameter substantially equal to the diameter of the associated duct 18 and to the diameter of an outlet port 42.

Each peripheral axial wall element 60 comprises, herein in the vicinity of its upper end, an attachment portion 62 capable of enabling it to be hooked onto the receiving portion 28 of the chassis 26 before the valve 14 is mounted in its housing 16.

According to the embodiment shown, the attachment portion 62 of each peripheral axial wall element 60 comprises an elastic interlocking member 64 capable of engaging with a complementary element of the receiving portion 28 of the chassis 26. This elastic interlocking member 64 herein takes the form of a flexible tongue 66 arranged in a window 68 formed in the attachment portion 62. At its free end, the flexible tongue 66 is provided with a lug 70 intended to hook into a notch 72 arranged in the receiving portion 28.

The receiving portion 28 comprises herein a tubular section 74 complementary to the main opening 22. Each notch 72 takes the form herein of an oblong slot or hole in the tubular section 74.

The attachment portion 62 is received in an annular axial groove 76 formed in the receiving portion 28 and adjoining the inner axial wall of the tubular section 74.

Advantageously, each radial opening 58 is provided with an annular seal 78 which is carried by the peripheral axial wall assembly 56, prior to mounting the valve 14 in its housing 16. This annular seal 78 is configured to be able to be interposed radially between the main body 36 of the plug 34 and a bearing surface 80 facing the receiving frame 12, when the valve 14 is mounted in its housing 16. The bearing surface 80 is herein an annular zone of the inner axial surface of the housing 16 which borders the inlet of the corresponding duct 18.

The annular seal 78 comprises for example an inner annular bead 82 which bears radially against the main body 36 of the plug 34 and an outer annular bead 84 which bears radially against the bearing surface 80 of the receiving frame 12.

Advantageously, each annular seal 78 is made from one single piece with the associated peripheral axial wall element 60, by molding two distinct materials, that is by injecting two materials into one mold. The peripheral axial wall element 60 and the annular seal 78 are for example injection-molded from a plastic material to obtain a relatively rigid peripheral axial wall element 60 and from an elastomer material to obtain a relatively flexible and compressible annular seal 78, when the valve 14 is inserted into its housing 16.

According to the embodiment shown, the main body 36 of the plug 34 has a generally frustoconical shape, decreasing in diameter towards the end opposite the chassis 26, herein the lower axial end.

The angle a1 described by the outer axial wall 40 of the main body 36 with respect to a direction A2 parallel to the main axis A1 is shown schematically. This angle a1 is for example between 2 and 6 degrees.

Advantageously, the assembly of peripheral axial walls 56 is configured so that its external dimension also has a frustoconical shape, matching the frustoconical shape of the main body 36 of the plug 34. As shown in FIG. 2, each peripheral axial wall element follows the inclination of the outer axial wall 40 with respect to direction A2.

It should be noted that the main outer peripheral wall of the main body 36 is referred to as the “outer axial wall”, even though this wall is slightly frustoconical and not exactly axially oriented, in order to facilitate the description of the structure of the plug 34.

The frustoconical shape of the main body 36 and the positioning of the peripheral axial wall elements 60 which are pressed against the outer axial wall 40 make it easier to mount the valve 14 in the housing 16, notably avoiding damage to the sealing elements during assembly. Indeed, the outer diameter of the peripheral axial wall assembly 56, at its lower axial end, is thus less than the outer diameter of the peripheral axial wall assembly 56, at its upper axial end. Also, as the housing 16 is configured to be complementary to the valve 14, it too has an inner main axial wall 86 of frustoconical shape complementary to the frustoconical shape of the assembly of peripheral axial walls 56.

Thus, when the valve 14 is inserted axially into the housing 16 from above, as shown in FIG. 2, the lower axial end of the valve 14 easily penetrates the housing 16, since this end has an outer diameter much less than the diameter of the housing 16 at the top. The valve 14 is inserted into the housing 16 until the annular seal 78 rests sealingly against the bearing surface 80 of the inner main axial wall 86 of the housing 16. The frustoconical configuration of the main body 36 and the housing 16 prevents any damage to the annular seal 78 as it passes in front of the internal orifices in the ducts 18, thus preserving the integrity of the annular seal 78 during assembly.

Advantageously, the peripheral axial wall assembly 56 comprises a tubular end portion 88, on the opposite side to the chassis 26, which is configured to axially guide the valve 14 when mounted in its housing 16. More precisely, the tubular end portion 88 is housed in a complementary lower end portion of the housing 16 which facilitates the centering of the valve 14 in the housing 16.

Preferably, the tubular section 74 of the chassis 26 is provided with an outer peripheral annular groove 90 and an O-ring seal 92 which is mounted in said outer peripheral annular groove 90 so as to ensure a tight fit of the chassis 26 in the housing 16.

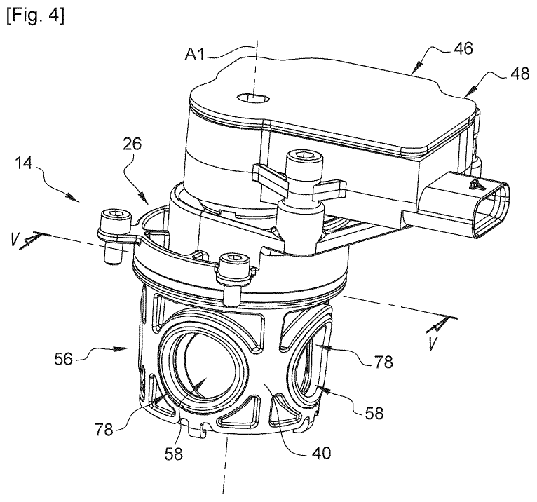

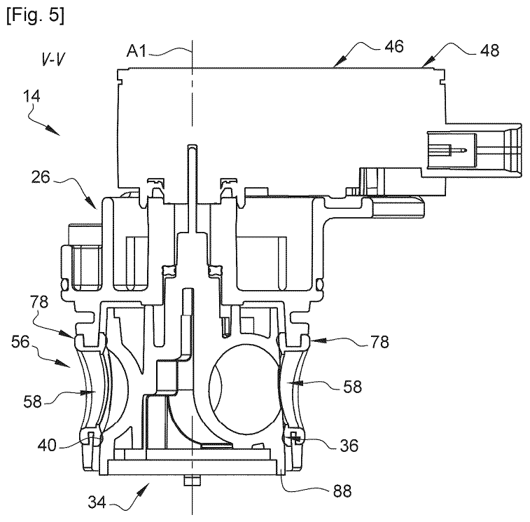

A second embodiment of the cartridge valve assembly 10 is now described with reference to FIGS. 4 and 5. The focus will be on describing mainly the technical differences between the second embodiment and the first embodiment. Identical technical features will not be described a second time.

The second embodiment differs from the first embodiment in that the peripheral axial wall assembly 56 is herein made from one single piece by molding with the chassis 26. According to this example embodiment, the four peripheral axial wall elements 60 only form a single, generally tubular wall which extends axially downwards from the chassis 26.

According to the second embodiment, neither an attachment portion nor elastic interlocking members are therefore required to secure the peripheral axial wall assembly 56 to the chassis 26.

Different variants of the invention can be envisaged, whether for the first or the second embodiment. In particular, the annular seal 78 can be manufactured separately from the peripheral axial wall assembly 56 and then mounted in the radial opening 58, for example by elastic interlocking. The peripheral axial wall assembly 56 and the annular seal 78 can also be made from one single piece of elastomer material, and overmolded onto the chassis 26.

The peripheral axial wall assembly 56 may comprise a different number of peripheral axial wall elements 60 to suit the number of ducts 18 arranged in the receiving frame 12. Likewise, the number of fluid passages 38 arranged in the plug 34 may differ from that shown in the figures.

According to another variant, the peripheral axial wall elements 60 can be attached to the chassis 26 by welding or by force-fitting.

The valve 14 described previously is highly modular, allowing the plug 34 and the peripheral axial wall elements 60 for example to be changed based on the number of fluid passages 38 and/or on the number of ducts 18 in the receiving frame 12 defined by the customer of the valve 14.

The valve 14 is particularly suited to a cartridge Liquid Multiway Valve (LMV) used to control the flow of a glycol-water mixture. It allows a low-torque motor to be used to control the position of the plug 34.

A multi-stage valve 14 can be provided. In this case, the assembly of peripheral axial walls 56 comprises several radial openings 58 superimposed axially.

The valve 14 is particularly compact. It ensures both a static seal with the receiving frame 12 and a dynamic seal with the outer axial wall 40 of the plug 34.

The valve 14 can be fully assembled at the manufacturer's premises, with the peripheral axial wall assembly 56 and the annular seals 78, optionally with the actuator 46, and then delivered complete to the customer who has a product comprising the receiving frame 12. This notably makes it possible to check and guarantee the internal seal, to reduce the number of parts to be referenced and facilitates assembly operations at the customer's premises.

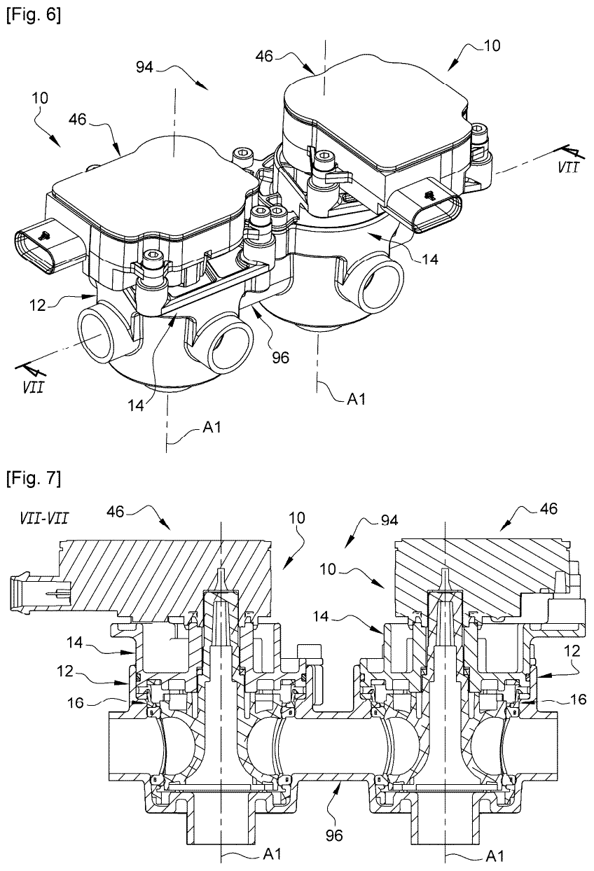

FIGS. 6 and 7 show a third embodiment comprising a fluid distribution manifold 94 fitted with two valve assemblies 10, each valve assembly 10 being constructed in accordance with the first embodiment shown in FIGS. 1 to 3.

The fluid distribution manifold 94 comprises a receiving frame 12 capable of receiving two valves 14 of the type described previously. The fluid distribution manifold 94 is for example molded from one single piece of plastic and comprises herein two housings 16 configured to receive the associated valves 14.

The two housings 16 are herein connected therebetween by a connecting duct 96 which forms one of the ducts 18 of the receiving frame 12.

The rest of the structure of the valve assemblies 10 and the operation of the two valves 14 are identical to those described for the first embodiment in FIGS. 1 to 3.

The technical advantages described for the first embodiment of the valve assembly 10 of course apply to the fluid distribution manifold 94 of FIGS. 6 and 7.

According to one variant (not shown), the fluid distribution manifold 94 could comprise more than two valves 14, connected by several connecting ducts 96, or else comprise a valve assembly 10 according to the second embodiment shown in FIGS. 4 and 5.

### LEGEND

10: valve assembly
12: receiving frame
14: valve
16: housing
18: duct
20: outlet opening
22: main opening
24: shoulder
26: chassis
28: receiving portion
30: attachment lugs
32: screw
34: plug
36: main body
38: fluid passage
40: outer axial wall
42: outlet port
44: drive shaft
46: actuator
48: housing
50: upper face
52: drive member
54: attachment studs
56: peripheral axial wall assembly
58: radial opening
60: peripheral axial wall element
62: attachment portion
64: elastic interlocking member
66: flexible tongue
68: window
70: lug
72: notch
74: tubular section
76: annular axial groove
78: annular seal
80: bearing surface
82: inner annular bead
84: outer annular bead
86: inner main axial wall
88: tubular end portion
90: outer peripheral annular groove
92: O-ring seal
94: fluid distribution manifold
96: connecting duct
a1: angle of frustoconical body with respect to direction A2
A1: main axis
A2: direction parallel to main axis

1. A cartridge valve intended to be mounted in a suitable housing provided in a receiving frame, comprising:
a chassis intended to be attached directly to the receiving frame,
a plug rotatably mounted on the chassis about a main axis of rotation, the plug comprising:
a main body provided with fluid passages opening into an outer axial wall of the main body via at least two outlet ports, and
a drive shaft which extends from the main body through a portion of the chassis, so as to be able to be coupled to an actuator capable of controlling the rotation of the plug,
a peripheral axial wall assembly which is integral with the chassis, prior to mounting the valve in its housing, the peripheral axial wall assembly being provided with a plurality of radial openings intended to be aligned inwardly with outlet ports in the plug, in determined angular positions of the plug, and outwardly with associated ducts of the receiving frame.

2. The valve according to claim 1, wherein the peripheral axial wall assembly comprises at least two added peripheral axial wall elements which are attached to the chassis so as to be able to be carried by the chassis before mounting the valve in its housing, each peripheral axial wall element being provided with a radial opening, each peripheral axial wall element comprising an attachment portion adapted to enable it to be hooked onto a complementary receiving portion of the chassis, prior to mounting the valve in its housing.

3. The valve according to claim 2, wherein the attachment portion of each peripheral axial wall element comprises an elastic interlocking member capable of engaging with a complementary element of the associated receiving portion of the chassis.

4. The valve according to claim 3, wherein the receiving portion of the chassis comprises, for each peripheral axial wall element, an axial groove capable of receiving the attachment portion and a notch capable of receiving, by elastic interlocking, the elastic interlocking member for retaining the attachment portion on the receiving portion.

5. The valve according to claim 1, wherein each radial opening is provided with an annular seal which is carried by the peripheral axial wall assembly, before mounting the valve in its housing, so as to be radially interposed between the main body of the plug and a bearing surface facing the receiving frame, when the valve is mounted in its housing.

6. The valve according to claim 5, wherein the annular seal and the peripheral axial wall assembly are made from one single piece by molding two separate materials.

7. The valve according to claim 1, wherein the main body of the plug has a frustoconical shape with a diameter decreasing towards an end opposite the chassis, and in that the peripheral axial wall assembly is configured so that its external dimension is also frustoconical in shape, matching the frustoconical shape of the main body of the plug.

8. The valve according to claim 1, wherein the peripheral axial wall assembly comprises a tubular end portion, on the opposite side to the chassis, which is configured to axially guide the valve when mounted in its housing.

9. A cartridge valve assembly comprising:
a valve according to claim 1,
a receiving frame provided with a housing adapted to the valve, the frame comprising at least two ducts which open into the housing via radial orifices intended to be radially aligned with the outlet ports of the plug in at least one determined angular position of the plug.

10. The cartridge valve assembly according to claim 9, comprising the valve, wherein the main body of the plug has a frustoconical shape with a diameter decreasing towards an end opposite the chassis, and in that the peripheral axial wall assembly is configured so that its external dimension is also frustoconical in shape, matching the frustoconical shape of the main body of the plug, wherein an internal main wall of the housing has a frustoconical shape generally complementary to the frustoconical shape of the main body of the plug equipped with the peripheral axial wall assembly.

11. The cartridge valve assembly according to claim 9, wherein the housing comprises a shoulder capable of receiving a tubular section of the chassis in axial abutment, and in that the tubular section of the chassis is provided with an outer peripheral annular groove and an O-ring mounted in said outer peripheral annular groove.
